(19) United States
(12) Patent Application Publication
(10) Pub. No.: US 2014/0278724 A1
(43) Pub. Date: Sep. 18, 2014

(54) BUSINESS PROCESS COMPLIANCE VIA SECURITY VALIDATION SERVICE ON THE CLOUD

(71) Applicants: Luca Compagna, Walldorf (DE); Serena Ponta, Walldorf (DE)

(72) Inventors: Luca Compagna, Walldorf (DE); Serena Ponta, Walldorf (DE)

(21) Appl. No.: 13/835,056

(22) Filed: Mar. 15, 2013

(51) Int. Cl. G06Q 10/06

(52) U.S. Cl. CPC G06Q 10/0633
USPC 705/7.27

(57) ABSTRACT

A computer-implemented method provides remote Security Validation as a Service (SVaaS) to one or more business process modeler clients. The method includes receiving on a cloud-based server, from a remote business process modeler client, a request for validation of a business process model and related information for a business process compliance problem including the business process work flow and security-related aspects of the business process. The method further includes sending the business process compliance problem from the server to a model checker for validation and receiving, at the server, validation results from the model checker and making the validation results available to the remote business process modeler client. The method can include enhancing the remote client with a connector module that is configured to collect information on the business process compliance problem and to communicate such information to the server.

### TECHNICAL FIELD

This description in general relates to business process modeling. In particular, this description relates to security compliance aspects of business process modeling.

### BACKGROUND

Business processes (BPs) can be a sequence of activities a business enterprise performs to produce a specific service or product for a customer. Business analysts can use business process modeling in order to generate a business process model (BPM) that, when executed, produces the product or service for the customer. The business process model can include one or more related structured activities or tasks that, when performed, produce the desired resultant product or service for the customer. Many business organizations can use business process modeling in order to increase business flexibility and efficiency as one or more business process models may use the same business process.

A key model-driven development principle underlying the BPM paradigm is that the business process which is run is the same one designed in the model.

When designing a business process, security requirements related to the execution of a business process task should be taken into consideration. The security requirements can include government mandated regulations and directives as well as mechanisms for fraud prevention. A business analyst, when generating a business process model, can work with a security analyst regarding the security requirements. The business analyst can determine human task assignments based on the security requirements. The business process modeling system can attempt to enforce the assignments within the business process model. However, the business process modeling system may not guarantee the assignments fulfill the necessary security requirements for the business process. The dynamic and frequently changing environment in which the business process executes may delegate certain assigned tasks within the business process complicating the meeting of the security requirements by the business process.

The business analyst can manually only partially test and tune the business model to meet the security requirements. In contrast, automated reasoning techniques such as model checking can validate all the execution paths of the business process under design against the expected security requirements. Model checking can run an analysis (a security validation) on a formal model of the business process that includes the security requirements. The security validation of the business process can ensure the compliance of the business process with respect to the relevant security requirements. The results of the model checking can provide information regarding a breach in a security requirement (a security attack). The results can be provided to the business analyst in a format conducive to their understanding of the business process model. The business analyst can choose to correct the security breach by modifying the business process model. For example, the business analyst may choose to correct or modify the business process flow that caused the security attack by reassigning resources for one or more specific tasks in the business process. In another example, the business analyst may choose to correct the security breach by changing the confidentiality or privacy constraints with regard to particular data used in the business process. In some cases, the business analyst may not be able to make a correction to eliminate the possible security attack but will inform those concerned in the next stage of the business process of the situation for manual monitoring.

Consideration is now being to ways of providing automated validation testing of business process models.

### SUMMARY

In a general aspect, a server is configured to remotely provide Security Validation as a Service (SVaaS) to one or more business process modeler (BPM) clients. The server includes an application programming interface (API) configured to receive, from a remote BPM client, a request for validation of a business process model and related information for a business process compliance problem (BPCP) including the business process work flow and security-related aspects of the business process. The business processes workflow may, for example, be specified in standard BPMN2 and the security-related aspects of the business process may, for example be specified, in the BPMN2-SEC described herein. The server also includes a model checking manager configured to send the BPCP to a model checker for validation and to receive validation results therefrom. The model checking manager may send a formal representation of the BPCP to the model checker. The formal representation of the BPCP may be obtained, for example, by translation by a BPC worker module in the server.

In an aspect, the API is configured to receive or create a unique BPCP resource object associated with the request for validation at a specific location on server. The unique BPCP resource object has a schema that includes at least a security policy element, a security property element and a result element. The BPCP schema may include the BPMN2 (OMG) standard schema and the BPMN2-SEC extension described herein. The API can be configured to accept PUT requests from the remote BPM client to place information for the business process compliance problem in the unique BPCP resource object associated with the request for validation at the specific location.

In an aspect, the server is configured to place the validation results in a BPCP resource object wherefrom the validation results are accessible by the remote BPM client. In a further aspect, the server includes a portal configured to provide a single web-based entry-point for the end-users to monitor their BPCP resources on the server.

In an aspect, the BPM client is enhanced with a connector module that is configured to collect information on the business process compliance problem and configured to communicate such information to the API on the remote server.

In an aspect, the BPCP is in Business Process Modeling Notation (BPMN) language, and the server includes a translation layer configured to translate the BPCP from BPMN language to a meta-language used by the model checker and to conversely translate the validation results received from the model checker from the meta-language to BPMN language. The BPMN language used may conform to BPMN2 (OMG) standard schema and extensions thereto (e.g., BPMN2-SEC extension described herein).

In a further aspect, the model checker processes for validation of the business process model are run on one virtual machine, and wherein a workers manager module in the server is configured start a new worker thread and a corresponding external virtual machine with a new instance of the model checker for a next request for validation received by the server as soon as workload criteria are met.

In a general aspect, the computer-implemented method provides Security Validation as a Service (SVaaS) remotely to one or more business process modeler (BPM) clients. The method includes receiving on a server, from a remote BPM client, a request for validation of a business process model and related information for a business process compliance problem (BPCP) including the business process work flow and security-related aspects of the business process, sending the BPCP from the server to a model checker for validation, and receiving, at the server, validation results from the model checker. The method further includes making the validation results available to the remote business process modeler client.

In an aspect, the method includes enhancing the BPM client with a connector module that is configured to collect information on the business process compliance problem and to communicate such information to the remote server.

In an aspect, the method includes creating a unique BPCP resource object associated with the request for validation at a specific location, wherein the unique BPCP resource object has a schema that includes at least a security policy element, a security property element and a result element.

In an aspect, the method includes placing the validation results received at the server in a BPCP resource object, wherefrom the validation results are accessible to the remote BPM client. In a further aspect, the method includes providing a single web-based entry-point on the server for the end-users to monitor their BPCP resources on the server.

In an aspect, the BPCP is in Business Process Modeling Notation (BPMN) language, and the method includes translating the BPCP from BPMN language (i.e. BPMN2 and BPMN2-SEC) to a meta-language used by the model checker, and translating the validation results received from the model checker from the meta-language to BPMN language.

A computer program product is tangibly embodied on a computer-readable storage medium and includes instructions that, when executed, enhance a business process modeler (BPM) client with a connector module.

In a general aspect, the connector module is configured to send, to a remote server, a request for validation of a business process model and related information for a business process compliance problem (BPCP) including the business process work flow and security-related aspects of the business process. The connector module is further configured to receive, from the remote server, validation results for the business process compliance problem.

The details of one or more implementations are set forth in the accompanying drawings and the description below. Other features will be apparent from the description and drawings, and from the claims.

### BRIEF DESCRIPTION OF THE DRAWINGS

FIG. 1 depicts an example system that can execute implementations of the present disclosure.

FIG. 2 is an example business process model using business process modeling notation (BPMN).

FIG. 3 is a flow diagram of a business process modeling (BPM) procedure that includes a security validation procedure in a BPM environment.

FIG. 4 is a flowchart depicting an example security validation process.

FIG. 5 is an example loan organization business process model using business process modeling notation (BPMN).

FIG. 6 illustrates an example model checker output raw attack trace where a need-to-know security attack is detected.

FIG. 7 illustrates a graphical view of an analysis result.

FIG. 8 is a flowchart of an example process for translating a raw output trace into an analysis result.

FIG. 9 is a flowchart of an example process for parsing a string step list to create workflow steps for an analysis result.

FIG. 10 is a schematic illustration of example computer systems that can be used to execute implementations of the present disclosure.

FIG. 11 is a schematic illustration of a business process model for a travel request approval process, in accordance with the principles of the disclosure herein.

FIG. 12 is block diagram illustration of an example architecture of a BP compliance validation system for providing Security Validation as a Service (“SVaaS”) to diverse business process modeler clients, in accordance with the principles of the disclosure herein.

FIG. 13 is a schematic illustration of example aspects or elements of BPMN2-SEC schema, which may be used for formulating or specifying the BPCP, in accordance with the principles of the disclosure herein.

FIGS. 14A-14D are examples of a BPCP specification prepared under BPMN2-SEC schema for the travel approval process of FIG. 11, in accordance with the principles of the disclosure herein.

FIG. 15 is block diagram illustration of a medium level view of the example architecture of the BP compliance validation system for providing Security Validation as a Service (“SVaaS”) to diverse business process modeler clients shown in FIG. 12, in accordance with the principles of the disclosure herein.

FIG. 16 is an example sequence diagram for creating a BPCP or validation resource, in accordance with the principles of the disclosure herein.

FIG. 17 is an example sequence diagram for returning a validation result to the BPM client, in accordance with the principles of the disclosure herein.

FIG. 18 is a flowchart illustrating an example computer-implemented method for providing Security Validation as a Service (SVaaS) remotely to one or more business process modeler (BPM) clients, in accordance with the principles of the disclosure herein.

Like reference symbols in the various drawings indicate like elements.

### DETAILED DESCRIPTION

In accordance with the principles of the present disclosure, security validation of business process models is provided as a centralized service (e.g., a cloud based service) to one or more diverse business process modeler/business process management system clients.

The provision of the centralized service for security validation of business process models, in accordance with the principles of the present disclosure, is described herein with reference to FIGS. 11-18. The provision of a centralized service for security validation of business process models, as described herein, may be contrasted with systems in which each business process modeler client conducts its own model checking or validation of a business process model, for example, on a related business process management system platform.

Commonly-assigned and owned U.S. patent application Ser. No. 12/943,698 titled “Security Validation of Business Processes” describes model checking or validation techniques and a validation tool, which can be run by individual business process modelers for validating a business process model on a related business process management system platform. For ease in cross-reference, FIGS. 1-10 of the aforementioned patent application showing implementations of the validation techniques and a validation tool disclosed therein are adapted as FIGS. 1-10 herein. Further, portions of the text describing the validation techniques and the validation tool with reference to the figures in the aforementioned patent application are also reproduced, mostly verbatim, below.

FIG. 1 depicts an example system 100 that can execute implementations of the present disclosure. The system 100 can include a client 102 and computer systems 106, 108. The computer systems 106, 108 can include servers 116, 118 and databases 112, 114, respectively. In some implementations, the system 100 may represent a client/server system supporting multiple computer systems (e.g., computer systems 106, 108) including one or more clients (e.g., client 102) and/or one or more servers (e.g., servers 116, 118) that are connectively coupled for communication with one another over a network 110. In some implementations, the clients (e.g., client 102) may be directly connected to the one or more servers (e.g., servers 116, 118) (without connecting by way of network 110).

The client 102 can represent various forms of processing devices including, but not limited to, a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any two or more of these data processing devices or other data processing devices. The client 102 may access application software on the servers 116, 118.

The servers 116, 118 can represent various forms of servers including, but not limited to a web server, an application server, a proxy server, a network server, or a server farm. For example, the server 116 can be an application server that executes software accessed by client 102. In operation, multiple clients (e.g., client 102) can communicate with the servers 116, 118 by way of network 110. In some implementations, a user can invoke applications available on the servers 116, 118 in a web browser running on a client (e.g., client 102). Each application can individually access data from one or more repository resources (e.g., databases 114, 116). For example, the servers 116, 118 can access databases 114, 116, respectively.

In some implementations, the client device 102 may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some implementations, the system 100 can be a distributed client/server system that spans one or more networks such as network 110. The network 110 can be a large computer network, such as a local area network (LAN), wide area network (WAN), the Internet, a cellular network, or a combination thereof connecting any number of mobile clients, fixed clients, and servers. In some implementations, each client (e.g., client 102) can communicate with the servers 116, 118 via a virtual private network (VPN), Secure Shell (SSH) tunnel, or other secure network connection. In some implementations, the network 110 can include the Internet, a wireless service network and may include the Public Switched Telephone Network (PSTN). In other implementations, the network 110 may include a corporate network (e.g., an intranet) and one or more wireless access points.

The client (e.g., client 102) can establish its own session with the servers 116, 118. Each session can involve two-way information exchange between the computer systems 106, 108 and the client 102. For example, a Hypertext Transfer Protocol (HTTP) session can allow the association of information with individual users. A session can be stateful session, in which at least one of the communicating parts (e.g., the servers 116, 118 or the client (e.g., client 102)) stores information about the session history in order to be able to communicate. Alternatively, stateless communication during a stateless session includes independent requests with associated responses

For example, referring to FIG. 1, the computer system 106 hosts a business process management system (BPMS) platform (e.g., SAP® NetWeaver® Business Process Management system) on the server 118. The client 102 accesses the BPMS platform by connecting to the computer system 106 by way of the network 110. A business analyst, using the client 102, can model, manage, monitor, and analyze business processes using the BPMS platform. The business analyst can implement business process improvements and dynamic modifications as part of the design of the business process model. A security validation tool can be a plug-in program for a development platform (e.g., the Eclipse platform) that provides an integrated development environment (IDE) for tool integration for the BPMS platform.

The BPMS platform can provide a user interface to the business analyst on client 102 (e.g., a graphical user interface (GUI) displayed on display device 102a). The business analyst can interact with the user interface in the design of and subsequent analysis of a business process model. For example, the user interface presents security requirements and parameters for a business process in a format readily understood by the business analyst. The database 112 can store the security requirements and parameters used in the business process. The business analyst, interacting with the user interface (e.g., selecting entries using a touch screen of the display device 102a, entering data using a keyboard 102b), can identify security requirements and set one or more parameters for a security requirement. The business analyst can activate a user control to initiate the model checking of the business process model using the entered security parameters. The client 102 can display the results of the model checking on the display device 102a in a manner easily understood by the business analyst. If the model check identifies a violation of a security requirement, the user interface can present to the business analyst the related data flow and resource allocations that caused the security violation.

The business analyst can determine if and how to prevent the security violation, update and change the data-related security requirements for the business process model, and initiate a model check for the updated business process model. The updating of a business model and the subsequent model checking can be iteratively performed until no security violations are detected or until the business analyst determines that the identified one or more security violations can be managed in the next process step.

FIG. 2 is an example business process model 200 using business process modeling notation (BPMN) (BPMN model 200). A business analyst can design the sequence of tasks 202a-g executed by business resources to perform the business process. For example, the business analyst can use an interactive graphical user interface with BPMN to design the BPMN model 200. In some implementations, one or more identified BPMN pools can interact with the tasks 202a-g, where the responsibility for the execution of the tasks 202a-g is in one of the identified pools. A pool can include one or more business resources (e.g., users) that contribute to the execution of the tasks 202a-g. The pools can interact with one another using a message exchange system. A message received from another pool can start the business process by triggering the task 202a. A message sent to another pool from the pool executing the tasks 202a-g can request information needed for the execution of a specific task.

The BPMN model 200 shows the flow of tasks 202a-g performed by business resources to achieve the business goal of the business process model. In some implementations, the business resources can be grouped into one or more resource roles. For example, users can be placed into resource roles such as clerical roles or managerial roles. An identity management tool can implement role based access control (RBAC) with delegation for business resources. The RBAC can be connected to a business process in order to the manage access control for the business resources in the business process model.

A business analyst can perform dynamic resource allocation by assigning user roles to a task. The assignment of user roles can provide the user with the authorizations needed to fulfill specific tasks for a business process within an organization. The use of RBAC along with business process modeling enables the defining of roles, users, user-to-role assignments and delegation rules for the business process model. For example, when designing the BPMN model 200, the business analyst associates with each task 202a-g of the BPMN model 200 a set of potential owners and a set of excluded owners. The owner or principal can be a business resource (e.g., a user) or a resource role (e.g., clerical, managerial).

When executing the business process model, a specific user can claim a task ready for execution, if the owners of the task includes the user, or if the user is assigned to the resource role associated with the task. In addition, the user cannot be included among the excluded owners or resource roles associated with the task. Once the user claims the task, the user can execute the task. In some situations, if the user cannot execute the claimed task (e.g., they are called away unexpectedly), the user can delegate the task to a delegated user. The delegated user is not included among the excluded owners or resource roles associated with the task. The ability to delegate task execution is an example of dynamic resource allocation.

When executing a task, a user may access data associated with the task. For example, the data can be in the format of a business process data object that includes one or more fields of data associated with the task. Performing the task can involve accessing one or more data objects associated with the task. The input to a task may require a user to access certain data fields in a data object in order to complete the task. In addition, once the task is complete, the user may access certain data fields in order to store the output of the task. The business analyst can associate one or more data objects with a task in the BPMN model 200.

A business analyst may require the business process to fulfill one or more security requirements. A need-to-know security requirement can restrict access to data based on a need-to-know basis. The need-to-know security requirement provides the principal assigned to a task access to the data for executing the task. In the case of a critical task, there may be additional data associated with the task that the principal assigned to the task may not access. A dual control, or four-eyes, security requirement can divide the responsibility of the execution of a task between two users. Both users complete their assigned duties related to the execution of the task in order to complete the execution of the task. The division of responsibility for the execution of a task can be referred to as a separation of duty security requirement. The division of responsibility for the task execution can mitigate the risk of fraud, for example. A data confidentiality security requirement can restrict access to data to specific users based on the confidential nature of the data.

The BPMN model 200 shows the tasks 202a-g in sequential order. A split, or fork 204 occurs where the business process model splits the task flow. The business process model can require the execution of task 202c and task 202d in parallel or simultaneously. A join 206 occurs in the business process model when the execution of both task 202c and task 202d are complete in order to merge the task flow.

FIG. 3 is a flow diagram of a business process modeling (BPM) procedure in a process composer module 300 that includes a security validation procedure 302 in a business process modeling (BPM) environment 304. A business analyst 306 can use the BPM environment 304 to define a business process model 308. The business analyst can use BPMN in a graphical user interface to design the business process model 308, an example of which is shown in FIG. 2. A security requirements specification module 310 can provide a user interface to the business analyst 306. For example, referring to FIG. 1, a BPMS platform can run the BPM procedure on the computer system 106. The business analyst 306 can use client 102 to interface with the computer system 106 by way of network 110 in order to run the BPM procedure. The client 102 can display the user interface (e.g., a GUI) on the display device 102a. The user interface can allow the business analyst 306 to specify security requirements 312 (e.g., need-to-know, data confidentiality and/or dual control security requirements) that the business process model 308 should meet. The security validation procedure 302 determines whether the designed business process model 308 meets the specified security requirements.

The implementation of the user interface includes a set of identified security requirements for compliance. For example, the business analyst 306 can perform a security validation procedure 302 where the security requirements specification module 310 provides a wizard in the form of a user interface on the display device 102a. The business analyst, using the wizard, can specify need-to-know, dual control, and/or data confidentiality security requirements, among other possible security requirements for the business process. For example, in the case where the business analyst specifies a need-to-know security requirement, the wizard can provide a user interface that includes the task and the data fields associated with the task that the user executing the task can access.

For example, the business analyst 306 can start the security validation procedure 302 in the BPM environment 304 by activating a user control (e.g., a button) on the user interface, once the business process model 308 is defined and the security requirements 312 for the business process model are entered using the security requirements specification module 310. A formal model translation module 314 generates a formal model 316 from the business process model 308 and the specified security requirements 312. The formal model translation module 314 provides the formal model 316 that includes the security relevant aspects of the business process model 308. The formal model translation module 314 includes an algorithm that translates the business process model 308, written in BPMN, to the formal model 316, where the formal model 316 can be written in a meta-language. For example, a formal model is a mathematical description of a software and/or hardware system that includes a mathematical representation of the requirements of the system. The formal model translation module 314 can generate the formal model 316 that includes a mathematical representation of the BPM environment, a mathematical representation of the business process modeled by the business analyst in BPMN, and a mathematical representation of the security requirements entered by the business analyst through the user interface provided by the security requirements specification module 310.

A model checker module 318 analyzes the formal model 316 and checks all potential execution paths of the business process model using the specified security requirements. If an execution path of the business process model violates a security requirement, the model checker module 318 identifies the violation. The analysis of the model checker module 318 produces an output result 328. A “no violation found” result 320 occurs when the formal model 316 satisfies the specified security requirements. The analysis of the model checker module 318 can result in “a violation found and violation trace” result 322. The violation found and violation trace result 322 includes an identification of the security violation found by the model checker module 318 along with a trace of the related data flow and resource allocations in the business process model that resulted in the security violation.

A model checking result translation module 324 translates the output result 328 (the no violation found result 320 or the violation found and violation trace result 322) into an analysis result 326. Specifically, the model checking result translation module 324 translates the output result 328 into a graphical representation of the identified compliance issue that is in a format that a business analyst 306 can easily understand. The client 102 can display the analysis result 326 to the business analyst 306 in the user interface (e.g., a GUI) in the easily recognizable format. The business analyst 306, understanding the output result 328 of the model checker module 318, can determine the security requirement changes necessary to correct for the security violation. The business analyst 306 can implement proper counter-measures in the business process model 308 to resolve the cause of the security violation. The business analyst 306 can incorporate the changes into the business process model 308 to provide a modified business process model 308′ and rerun the security validation procedure 302 in order to determine whether the counter-measures implemented resolved the security violation, and whether other security violations are present.

In some implementations, the formal model translation module 314 can generate a formal model 316 using a specification meta-language (e.g., the AVANTSSAR Specification Language (ASLan)) that can allow for the execution of the tasks in a business process by the model checker module 318 in every possible way in order to identify security violations. The model checker module 318 can evaluate a transition system with respect to the security requirements 312 where the security requirements 312 define the security properties the business process model 308 must achieve. For example, a transition system is an abstract machine used for system computations. The machine can include a set of labeled states and transitions between states, where the labels are chosen from a set of labels. The formal model 316, specifically the representation of the BPM environment and the representation of the business process modeled by the business analyst in BPMN, defines a transition system. In this case, the transition system can represent the total number of sequences of tasks executed by the business resources, or software agents, that are allowed to perform the tasks. In addition, the formal model 316 can describe data and documents used within a task along with the resource requirements needed to access the data and documents. States of this transition system are sets of facts that satisfy a set of clauses (e.g., Horn clauses). The clauses provide a declarative mechanism to specify the dependencies among the facts. Rewrite rules enable the specification of transition rules. For example, an ASLan specification includes an initial state, clauses, rewrite rules, and security properties defined as violation states.

The attack states can be sets of facts that violate the desired properties of the transition system. For example, an attack state specification in ASLan can be syntactically similar to a rewrite rule. As a result, if the model checker module 318 identifies an attack state, the set of rules leading to the violation of the security requirements and provide the resultant violation trace. For example, the sequential tasks in a business process model can be expressed using rewrite rules that manage the facts ready(t) and done(t) in ASLan in a control flow. When the control flow indicates that a task is ready to be executed, the actual execution of the task can require a user who is willing and authorized to perform the task according to the access control security properties associated with the task. Clauses in ASLan can designate the set of potential owners and the set of excluded owners, as well as the users, that are authorized to execute the task. In dynamic resource allocation, a user can claim a task and then delegate the execution of the task to a delegated user where the delegated user is not included among the excluded owners or resource roles associated with the task. For example, ASLan can express the delegation of the task execution using a rewrite rule stating the delegated user receives the duty to execute the task from the user who claimed the task.

The data fields for business process data objects provide static information associated with a task. For example, ASLan can represent the data fields with facts that are included and held in the initial state during the business process execution. The association of inputs to a task and the association of outputs to a task are performed using the facts included in the initial state. In some implementations, execution of a task includes accessing data. In some situations, a user can delegate the execution of the task to a delegated user. As the execution of the task can involve data access, a delegated user may access data objects the delegated user does not have permission to access.

FIG. 4 is a flow chart of a business process modeling process 400 that includes security validation. For example, the modules described in the process composer module 300 in FIG. 3 can perform the process 400.

The process 400 starts with defining a business process model (402). For example, the business analyst 306 can define a business process model using BPMN (e.g., BPMN model 200 in FIG. 2). The BPMN model 200 can be input as the business process model 308. The security requirements for the business process model are specified (404). For example, the business analyst determines need-to-know, dual control, and/or data confidentiality among other possible security requirements for the business process. The security requirements specification module 310 can provide a user interface to the business analyst 306 to enable the business analyst to enter the security requirements for the business process model 308. A formal model is generated based on the business process model and the security requirements (406). For example, the formal model translation module 314 generates the formal model 316 from the business process model 308 and the specified security requirements 312. The formal model is analyzed (408). For example, the model checker module 318 analyzes the formal model 316. The results of the analysis of the formal model is output (410). For example, the model checker module 318 generates output result 328 that indicates whether a security violation was found, and, if so, the identity of the security violation and a violation trace leading to the security violation. A graphical representation of the results is generated (412). For example, the model checking result translation module 324 translates the output result 328 into analysis result 326, which is a graphical representation of the identified compliance issue that is in a format easily understood by the business analyst 306. The graphical representation of the identified compliance issue can be incorporated into the BPMN model 200 used to represent the business process allowing the business analyst 306 to identify where within the business process and under what conditions the security attack occurred. The process 400 ends.

FIG. 5 is an example loan organization business process (LOBP) model 500 that can be generated using BPMN. For example, a business analyst can model a loan process for a bank to provide the LOBP model 500. Referring to FIG. 1, the business analyst can interact with a GUI on display device 102a of client 102 to design the LOBP model 500 using BPMN. The display device 102a can display the LOBP model 500.

The LOBP model 500 includes a sequence of tasks 502a-g that when executed by one or more business resources (e.g., users) can evaluate and possibly grant a bank customer a request for a loan amount. The business analyst assigns a bank resource role to each task. In the example of FIG. 5, a pre-processor clerk role 504 is assigned to tasks 502a-b, a post-processor clerk role 506 is assigned to tasks 502c-d, task 502e, and task 502g, and a bank manager role 508 is assigned to task 502f.

The tasks 502a-g can involve interaction with a customer pool 510, a bank pool 512, and a credit bureau pool 514. In the example of FIG. 5, the tasks 502a-g are included in the bank pool 512. The bank pool 512 can communicate with the customer pool 510 and the credit bureau pool 514 using a message exchange system in order to send and receive data and information related to the execution of the tasks 502a-g. Messages 516a-c can be communicated between the customer pool 510 and the bank pool 512 in order to exchange data and information between the bank and the customer. Messages 518a-b can be communicated between the credit bureau pool 514 and the bank pool 512 in order to exchange data and information between the bank and the credit bureau.

For example, a loan request message 512a represents the customer going to the bank to request a loan. The receipt of the loan request message 512a by the bank pool 512 triggers the start of the LOBP at the bank. The pre-processing clerks included in the pre-processing clerk role 504 receive and identify the customer's request at start 520. The pre-processing clerks launch the LOBP at the bank and update and/or create customer data 522 in the banking system by executing an input customer data task 502a. The pre-processing clerks execute a customer identification task 502b using the customer data 522 in order to identify the bank customer.

The post-processing clerk(s) included in the post-processor clerk role 506 analyze the credit worthiness of the identified customer. A split 524 in the LOBP occurs as the LOBP performs two or more tasks in parallel (tasks 502c and 502d). The post-processing clerk(s) execute an internal rating check task 502c to check the credit worthiness of the customer based on past bank transactions. In addition, the post-processing clerks execute an external credit worthiness check task 502d by communicating customer data to an external credit bureau, represented by a send customer data message 518a, in order to obtain credit worthiness data and information (e.g., a credit rating) for the customer.

The results of the external credit worthiness check task 502d are returned to the bank as represented by a send result message 518b from the credit bureau pool 514 to the bank pool 512. A join 526 occurs in the LOBP when the LOBP completes the execution of the parallel tasks 502c and 502d. The post-processing clerks execute a select bundle product task 502e to identify the most appropriate bundle product for the customer that includes the price of the loan. The bank submits to the customer a loan proposal along with the loan as represented by a loan proposal message 516b. In the case of the acceptance of the loan proposal, the customer signs the loan contract and returns it to the bank as represented by a loan contract message 516c. The returned and signed loan contract is provided to the bank manager. The bank manager executes a sign form task 502f in order to approve the loan. Once the bank manager approves the loan, the post-processing clerks execute an open account in system task 502g that opens a customer account for the loan in the banking system. The LOBP ends 538.

In addition, the pre-processing clerks manage a customer's external credit scoring data 528, a customer's rating report 530, a bundled product offered to a customer 532, a loan contract 534 and loan account data 536.

The LOBP model 500 can be associated with one or more security requirements. For example, the business analyst can specify one or more security requirements that are applicable to one or more of the tasks 502a-g of the LOBP model 500 as discussed above with reference to FIG. 3 (e.g., security requirements 312). The LOBP 500 and the security requirements are provided as input to a formal model translation module (e.g., the formal model translation module 314 of FIG. 3), which generates a formal model based thereon (e.g., the formal model 316 of FIG. 3). The formal model is provided as input to a model checker (e.g., the model checker 318 of FIG. 3), which processes the formal model to determine whether the business process violates any of the specified security requirements, as discussed above. The model checker outputs results that can include a simple indication that no violation was found, or that a violation was found. If a violation is found, a corresponding violation trace is also provided as part of the output result.

FIG. 6 illustrates an example model checker output raw violation trace 600 for the example LOBP model 500 of FIG. 5. In particular, the violation trace 600 is based on a violation of a need-to-know security requirement. Referring to FIG. 3, the violation trace 600 can be included in the output result 328 of the model checker module 318, specifically the violation found and violation trace result 322.

The violation trace 600 shows the output business process model trace leading to the security requirement violation. For example, referring to FIG. 5, the user selecting the loan offer (the post-process clerk selecting the bundled product for the customer) should not have access to specific customer data such as the customer's name or gender. The model checker module 318 outputs the violation found and violation trace result 322 indicating a violation of a need-to-know security requirement (e.g., the user can access customer data designated inaccessible by the security requirement). The violation found and violation trace result 322 includes the identification of the violation found and the raw violation trace 600.

For example, in the violation of the need-to-know security requirement for the LOBP model 500, the violation found can be expressed by the following statement: needToKnow_name(paul, out_all_inputcustomerdata). The violation found indicates that the user “Paul” violates the need-to-know security requirement. Referring to FIG. 5, the user Paul can access the data fields “name” and “gender” in a data object included in the customer data 522. The user Paul can access the data fields “name” and “gender,” because the user Paul can execute the input customer data task 502a and output the results of the task (e.g., the customer data 522). The user Paul can execute the input customer data task 502a because the pre-processing clerk “John” delegated the task to the post-processing clerk Paul and the input customer data task 502a is assigned to the pre-processor clerk role 504. The user Paul can execute the select bundled product task 502e in his role as a post-processing clerk as the select bundled product task 502e is assigned to the post-processing clerk role 506. In this situation, a security requirement violation occurs when the task of selecting the bundled product for the customer is assigned to user Paul (rule 622a of task 622) or when the input customer data task 502a is delegated to the user Paul.

The violation trace 600 indicates the flow that produced the security requirement violation. For example, the violation trace 600 includes a sequence of sets of instantiated ASLan rewrite rules that when executed result in the security requirement violation. The sequence of sets of instantiated ASLan rewrite rules are grouped according to their associated task. For example, rewrite rule instances represent rewrite rules 604a, 606a, 608a associated with task 602 (e.g., the input customer data task 502a in FIG. 5).

The square brackets (e.g., square brackets 624a-b) group rewrite rule instances that belong to the same execution step. Rewrite rules 604a, 606a, 608a belong to execution steps 604, 606, 608, respectively. Rules belonging to execution step i have to be executed before rules belonging to execution step j for any j>i (e.g., rule 604a in execution step 604 is executed before rule 606a in execution step 606). In addition, rules belonging to the same execution step may be executed in any order (e.g., rule 614a and rule 614b in execution step 614 can be executed in any order).

The model checking result translation module 324 can translate the raw attack trace 600 into a graphical format that can be presented to the business analyst in a GUI on a display device that can be more easily followed and understood by the business analyst. The graphical format is provided as analysis result 326 of FIG. 3.

In some implementations, the business analyst can set the post-processor clerk role 506 as an excluded owner for the input customer data task 502a in an updated business process model (e.g., BPM 308′ of FIG. 3) to prevent the security violation. However, this particular setting of the post-processor clerk role 506 does not fulfill the security requirements. A subsequent security validation check of the updated business process model identifies a security violation where the pre-processing clerk John executes the input customer data task 502a and is then delegated by Paul to execute the select bundled product task 502e.

Because the execution of tasks can be delegated to users in any role, the business analyst can define excluded individual owners for particular tasks. Defining excluded individual owners can prevent roles other than the roles identified as the potential owner of the task from delegating the execution of a task to users in other roles. The business analyst can run the security validation check and define excluded individual owners for particular tasks to correct for identified security requirements violations until no attack traces are detected by the security validation check. Alternatively, the business analyst can run the security validation check and define excluded owners for particular tasks until the business analyst acknowledges the risk posed by the remaining attack traces detected by the security validation check. For example, the business analyst can put in place monitoring systems to prevent fraud when the business process is executed.

FIG. 7 illustrates a graphical view 700 of an analysis result (e.g., analysis result 326 of FIG. 3). For example, referring to FIGS. 1, 3, 5, 6 and 7, the graphical view 700 shows a violation of a need-to-know security requirement for the LOBP model 500. The model checking result translation module 324 translates the model checker output raw attack trace 600 included in the attack found and attack trace result 322 and, along with the identification of the attack found, produces analysis result 326 for display in the graphical view 700. The model checking result translation module 324 can incorporate the translation of the attack found and attack trace result 322 into the LOBP model 500 resulting in the graphical view 700. The display device 102a of client 102 can display the graphical view 700 to the business analyst. The business analyst can interact with a GUI on display device 102a of client 102 to review the graphical view 700 in order to determine where in the business process model the identified security violation occurred.

Property violation frame 702 shows the details of the identified security requirement violation. In some implementations, a business process model may violate one or more security requirements. The property violation frame 702 can show the details of each of the violated security requirements determined by the security validation procedure 302 in FIG. 3.

Counter example frame 704 shows the details of the business process tasks executed that result in the identified security requirement violation. The counter example frame 704 groups the executed ASLan rewrite rules that result in the security requirement violation with the associated business process task. In the counter example frame 704, execution steps 604, 606, 608 are shown as they relate to the input customer data task 502a as execution step entries 706, 708, 710, respectively, grouped together under an input customer data entry 712. Execution steps 620, 622 are shown as they relate to the select bundled product task 502e as execution step entries 714, 716, respectively, grouped together under an input customer data entry 712b. The counter example frame 704 highlights the one or more execution steps (e.g., execution step entry 716) that violated the security requirements.

Graphical counter example frame 714 shows a GUI representation of the business process model similar to the LOBP model 500. The graphical counter example frame 714 highlights the one or more tasks associated with the security requirement violation. For example, executed input customer data task 716a (corresponding to modeled input customer data task 502a) is highlighted as the user Paul was able to access the data fields “name” and “gender” in the customer data 522 (e.g., user Paul was included is included in the pre-processor pool 506). Executed select bundled product task 716e is highlighted as the same user, Paul, was assigned to the select bundled product task 502e. In order to execute the select bundled product task 502e, the user Paul may not access the data fields “name” and “gender” in the customer data 522, resulting in a need-to-know access violation. Therefore, the highlighted executed input customer data task 716a and the highlighted executed select bundled product task 716e indicate the executed tasks resulting in the security requirement violation. In addition, the graphical counter example frame 714 shows the user that claimed, delegated, or executed the task (e.g., users 718a-e associated with executed tasks 718a-e, respectively).

Commands and controls frame 720 includes buttons and controls a business analyst can use when interacting with the GUI of the graphical view 700. Caption frame 722 indicates the meaning of the colors used in the graphical view 700. For example, different colors can be used to represent if the user associated with a task claimed, delegated or executed the task.

In the case where the business process model does not violate any of the specified security requirements, the graphical view 700 can display a message to the business analyst informing the business analyst that no security violation was found.

FIG. 8 is a flowchart of an example process 800 for translating a raw output trace (e.g., raw output trace 600 in FIG. 6) into an analysis result (e.g., analysis result 326 in FIG. 3). The process 800 is described with reference to FIGS. 1 and 3. The process 800 starts by determining whether a security violation occurred (802). For example, the model checking result translation module 324 parses the model checker output result 328 to determine if a security violation occurred. If it is determined that a security violation did not occur, a no violation message is displayed (804). For example, a GUI on the display device 102a of client 102 can display a no violation message to the business analyst.

If it is determined that a security violation did occur, the type of security violation is determined (806). For example, the model checking result translation module 324 analyzes the violation found and violation trace result 322 to determine the violation type (e.g., the model checking result translation module 324 parses the needToKnow_name(paul, out_all_inputcustomerdata) statement to determine the attack type). The violation type can include but is not limited to a violation of confidentiality: forbidden user or role violation type; a violation of confidentiality: forbidden organization violation type; a separation of duty violation type; a binding of duty violation type; and a need-to-know violation type. The process 800 parses the model checker results (808). For example, the model checking result translation module 324 parses the violation found and violation trace result 322 to extract relevant information from the violation trace result for the violation type. Parsing a raw violation trace (e.g., raw violation trace 600 in FIG. 6) provides violation steps performed by the execution of one or more tasks that the model checking result translation module 324 tokenizes into a list of strings (a violation step list). The process 800 generates workflow steps (810). For example, the model checking result translation module 324 uses the violation step list to create one or more workflow step objects. The workflow step objects can be displayed to the business analyst as part of the analysis result. The workflow step objects are created according to the detected security violation steps. A workflow step object can be created and inserted into a business process task. The process 800 generates the graphical view based on the workflow steps (812). For example, the model checking result translation module 324 creates workflow step objects for the analysis result 326, which are displayed in a GUI to the business analyst in a manner the business analyst can easily understand (e.g., the graphical view 700). The process 800 ends.

FIG. 9 is a flow diagram of an example process 900 for parsing a violation step list to create workflow steps for an analysis result. For example, the process 800 of FIG. 8 can produce the violation step list by parsing a raw violation trace (e.g., raw violation trace 600 in FIG. 6) for a determined violation type (e.g., a need-to-know security violation). The process 900 can extract entity names (e.g., the names for roles, users and tasks) and remap them to their business process model system counterparts. The process 900 uses task authorization to recursively look for substituted roles until the process 900 finds a role belonging to the assigned user. The process 900 is executed for each tokenized string in the attack step list.

The process 900 begins by setting an index i equal to one (902). The process 900 determines the step type corresponding to the string step with index i (904). The string step can be a step executed within a task that leads to a subsequent security violation. The string step type can include but is not limited to a grant delegation of permission type; a human task execution type; an automatic task execution with principal propagation type; an automatic task execution with no principal propagation type; an authorize task execution type; a substitution type; a main step type; and a delegation type.

In the case of a grant delegation of permission string step type or a human task execution string step type, the process 900 extracts entity names from the step. Referring to FIG. 3, a related BPMN message flow object for each entity name is determined using a mapping that was stored during the translation phase performed by the model checking result translation module 324 on the output result 328. The entity name and its related BPMN message flow object can be stored in a step subclass object. The process 900 can add the step subclass object to the corresponding parent step of the BPMN process model. In the case where the parent step does not exist, the process 900 can use the step subclass object to create the corresponding step.

In the case of an automatic task execution with principal propagation string step type, the process 900 determines an automated task. The determined automated task, a channel on which the task can send messages, and a receiving organization for the messages, are BPMN objects. The channel can be a message flow connector object that connects automated tasks with a service provider. In addition, the channel can be a message flow connector object on which the automated task sends the principal's propagation information (e.g., the principal's authorization token). The process 900 can create an object that receives the automated task, the message flow connector object and the destination organization along with a user and a role as parameters. In some implementations, the object can be included with the corresponding parent task step of the BPMN process model. In the case of an automatic task execution without principal propagation string step type, the process 900 determines the automated task and processes the string step type, as in the case of an automatic task execution with principal propagation string step type except there is no principal propagation. Without principal propagation, there is no information regarding users or roles.

In the case of a substitution string step type, if the process 900 finds a substitution, the process 900 stores the substitution in a list of substitutions for further use by the process 900.

In the case of an authorized task execution string step type, the process 900 extracts a user, role and task. If the user associated with the task does not have the role associated with the task, the process 900 searches the substitution list for a substitution that meets the criteria. The process 900 creates a step that associates the user, role, and substituted user with the task. In the case where the user associated with the task does have the role associated with the task, the process 900 need not search for or provide a substitution. In the case where the process 900 finds no substitution, then process 900 cannot provide a substitution. The process 900 adds the step to the parent task step.

In the case of a main string step type, the process 900 creates a BPMN task step using a corresponding BPMN message flow object.

In the case of a delegation string step type, the process 900 creates a delegation step that includes the extracted task owner and the user and the roles of the extracted task owner and the user along with the delegated activity. The delegation step is added to an existing parent task step.

If the step type is determined to be a main step type (906), the process 900 extracts the workflow object for the string step with index i (908). The process 900 creates a main flow object based on the workflow object for the string step with index i (910). In this case, a BPMN task for the main flow object is created for inclusion in the analysis result for display to the business analyst.

If in it is determined that the step type is not a main step type (906), a workflow object is created based on the string step with index i (912). The workflow object created based on the string step with index i is appended to a workflow object as a step to an existing workflow object step (914). In this case, the workflow object is appended to an associated BPMN task for inclusion in the analysis result for display to the business analyst. If the index i is equal to the maximum index value, i.sub.max, (916), then process 900 has processed all strings in the attack step list and the process 900 ends. If the index i is not equal to the maximum index value, i.sub.max, (916), then the index i is incremented by one (918) and the process 900 at 904.

Referring now to FIG. 10, a schematic diagram of an example computing system 1000 is provided. The system 1000 can be used for the operations described in association with the implementations [of the validation tool] described herein. For example, the system 1000 may be included in any or all of the server components discussed herein. The system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the system 1000. In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In one implementation, the memory 1020 is a computer-readable medium. In one implementation, the memory 1020 is a volatile memory unit. In another implementation, the memory 1020 is a non-volatile memory unit. The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device. The input/output device 1040 provides input/output operations for the system 1000. In one implementation, the input/output device 1040 includes a keyboard and/or pointing device. In another implementation, the input/output device 1040 includes a display unit for displaying graphical user interfaces.

### Security Validation as a Service (SVaaS)

As noted previously, the provision of the centralized service for security validation of business process models, in accordance with the principles of the present disclosure, is described herein with reference to FIGS. 11-18.

FIG. 11 shows a business process model for a travel request approval process 1100. Travel request approval process 1100 may be used as a working example for the centralized service for security validation of business process models described with reference to FIGS. 12-18 herein.

In travel request approval process 1100, a staff member may submit a travel request for managerial approval. Two aspects (e.g., a purpose of travel and a travel budget) of the travel request may have to be reviewed and approved before the staff member is notified if his or her travel request is granted or not. Thus, travel request approval process 1100, as shown in the figure, involves four tasks—requesting travel 1101, approving the purpose of the travel 1102, approving the travel budget 1103, and notifying the requestor 1104. The execution of a task in travel request approval process 1100 may be user-centric or automatic. In the latter case, a business process management system may execute a service that implements the task (e.g., task 1104) without user interaction; in the former case (e.g., tasks 1101-1103), a person may be responsible for claiming and executing the task.

It may be expected that compliance and company policy requirements apply to the business process model for travel request approval process 1100. For example, an access control specification (e.g., role-based access control) may require that only certain persons (e.g., managers) approve the travel purpose and the travel budget. Further, separation of duty (SoD) constraints (e.g., SoD 1105, 1106 and 1107) may require that the person requesting travel, the person approving the travel purpose, and the person approving the travel budget are all different persons.

Incorporating the compliance and company policy requirements in a business process model may present a validation problem i.e. ensuring that the process is executable without contradicting any of the incorporated compliance and company policy requirements. This validation problem may be formulated and referred to herein as the “Business Process Compliance Problem (BPCP)” object.

For example business process model 1100, the Business Process Compliance Problem (BPCP) may be stated as: ensuring that the access control specification and the SoD constraints do not contradict each other to ensure that the process is actually executable respectful of its compliance and security requirements.

As described in the foregoing with reference to FIGS. 1-10, one or more of system 100 (FIG. 1), process composer module 300 (FIG. 3), and/or business process modeling process 400 (FIG. 4) may, for example, be used for validating the BPCPs for business process models (BPMs). In addition to testing that the technical behaviours of the BPM client platform (e.g., client 102) and the software services employed by the business process are as expected, validating the BPCP may require testing that business process execution within the BPM client does not violate any of the expected security requirements. This testing activity may be recast into a security validation problem that may be performed at design time by considering information from the BPM client runtime environment (e.g., users, roles, delegation policy, regulations, etc.).

Security Validation of business processes on the BPM client platform to detect BP compliance issues at design time, which may be based on a combination of model-checking, accessible user interfaces and graphical rendering of the outcomes, are described in the foregoing with reference to FIGS. 1-10.

In accordance with the principles of the present disclosure, Security Validation of business processes may be provided as a centralized service (e.g., a cloud based service) to one or more diverse business process modeler clients.

FIGS. 12 and 15 show high and medium level views, respectively, of an example architecture of a BP compliance validation system 1200 for providing Security Validation as a Service (“SVaaS”) to diverse business process modeler clients in accordance with the prinicples of the disclosure herein. In particular, FIG. 12 shows, in a high level view, a remote SVaaS server 1210 that is configured to provide security validation services to one or more BPM clients (e.g., client 1230). SVaaS server 1210, which may hosted on a cloud-based platform 1211, may be coupled to BPM client 1230 via a SVaaS connector 1220 disposed at the client site. SVaaS server 1210 may utilize the services of one or more remote model checkers (e.g., SATMC 1240) to check business models of BPM client 1230. SVaaS connector 1220 may be configured to mediate the SVaaS interactions of BPM client 1230 with SVaaS server 1210. BPM client 1230 augmented with SVaaS connector 1220 may be referred to herein as a “SVaaS-enabled BPM client 1231” as shown in the figure.

A business analyst may develop a business process model at BPM client 1230 and avail of validation services provided by SVaaS server 1210 by presenting the business process model to SVaaS connector 1220 for validation testing. SVaaS connector 1220 may be configured to retrieve or collect security-relevant information or the validation of the business process model, wrap the security-relevant information in a Business Process Compliance Problem (BPCP) object 1250, and initiate the validation testing by invoking SVaaS server 1210. The validation may be processed by SVaaS server 1210, which may be configured to transform the BPCP resource into a formal specification suitable for formal analysis by a model checker (e.g., SAT-based model checker 1240). SAT-based model checker 1240 may provide a raw result of its formal analysis to SVaaS server 1210. The latter may be further configured to convert the raw result into a proper XML result output format suitable for presentation to the business analyst/BPM client 1230.

SVaaS connector 1220 may be configured to prepare or formulate BPCP 1250 in a format (e.g., an XML format) that is reasonably independent of the characteristics of the diverse BPM clients (e.g., BPM clients 1230) that may avail of SVaaS provided on platform 1211 by SVaaS server 1210. The formulation of BPCP 1250 may, for example, be based on an industry-standard BPMN 2.0 XML specification, which has been promulgated by the Object Management Group (see e.g., website omg.org/spec/BPMN/2.0, January 2011).

In accordance with the principles of the disclosure herein, the BPMN2.0 standard schema may be extended, for formulating the BPCP, with an extension for security (referred to as herein as BPMN2-SEC) that is particularly defined to capture security-relevant aspects of business processes (FIG. 13). The terms “Business Process Modeling Notation (BPMN)” schema or language as used hereinafter will be understood to include the BPMN or BPMN2 OMG standards and, in context, also the BPMN2-SEC defined herein.

The formulated BPCP (e.g., BPCP 1250) may be configured as a Representational State Transfer (REST) resource that is commonly accessible, for example, by SVaaS server 1210 and SVaaS connector 1220. Each REST resource corresponding to a BPCP (e.g., BPCP 1250) may, for example, include two elements:
(1) The business process workflow (in standard BPMN2 format), which may be optionally augmented with more details on Data Objects and their task input/output; and
(2) The security-relevant aspects of the business process and corresponding validation results, both specified in BPMN2-SEC format.

SVaaS server 1210 may be further configured to convert the raw validation result provided by SATMC 1240 by into a proper XML result output format (i.e. BPMN2-SEC format) that may be added to the BPCP resource. SVaaS connector 1220 may access the BPCP resource and render the model checker's result on BPM client 1230, for example, for consideration by the business analyst. Alternatively or additionally, the results may be placed SVaaS sever 1210 in the cloud, where they can be directly accessed or consulted, for example, by the business analyst.

FIG. 13 shows example aspects or elements of a BPMN2-SEC schema 1300, which may be used for formulating or specifying the BPCP by SVaaS connector 1220, in accordance with the principles of the disclosure herein. In particular, as shown in the figure, BPMN2-SEC 1300 may include three specific elements: a policy 1310, which governs the targeted BP and BPM client 1230; security properties 1320, which the business process is expected to satisfy; and a validation result 1330 (if already obtained).

Policy 1310 may, for example, include elements 1311 and 1312 that respectively correspond to a Role-Based Access Control (RBAC) that is relevant for the business process and a delegation policy applicable to the BPM client.

Element 1311 in policy 1310 may allow specification of the roles and the users involved in the business process, the permissions, and the assignment of these permissions to users and roles. FIG. 14A shows, for example, a listing portion 1410 related to RBAC in an example BPCP specification prepared under BPMN2-SEC schema 1300 for travel approval process 1100 of FIG. 11. With reference to the figure, lines 2-7 in listing portion 1410 state that Manager, Staff, and Reception are roles, lines 8-11 indicate that Mickael is a user (lines 8-11), and line 12 states that Manger is a role assigned to Mickael. Further, two permissions are defined at lines 15-20 and lines 21-25, respectively. The permission at lines 15-20 allows execution of the Approve Travel activity or task, and the permission at lines 21-25 prohibits, via the “negate” construct, execution of the Request Travel activity or task in travel approval process 1100. Lines 29-30 assign the Approve Travel activity or task to the Manager role and lines 21-25 assign the prohibition on execution of the Request Travel activity or task to the Reception role

With renewed reference to FIG. 13, element 1312 in policy 1310 may allow specification of the delegation policy employed by the BPM client during the execution of the business process. The delegation policy may define under which conditions (if any) a user involved in a certain task of the business process may delegate the task to another person (e.g., a colleague). BPMN2-SEC schema 1300 may, for example, support the following standard delegation concepts:
(1) Delegation of execution—applicable when a user (e.g., because of sudden unavailability) delegates the execution of that task to another user. This delegation may be limited for the period of time necessary to execute the task.
(2) Delegation of permission—a user may delegate his/her permission to another user over a certain time-frame. This type of delegation may be particularly useful when a user is not available over the certain time-frame due to planned vacation or sick leave.

Further, BPMN2-SEC schema 1300 may provide two techniques—implicit and explicit, for specifying the delegation policy. In the implicit technique, a simple language may allow for quickly specifying standard delegation policies. In the explicit technique, a set of delegation rules may allow for specifying complex, elaborate or very specific delegation policies.

FIG. 14B shows, for example, a listing portion 1420 of a BPCP specification that includes three examples of implicit delegation policies on lines 1-9, lines 12-21 and lines 23-32, respectively, for travel approval process 1100 of FIG. 11. Lines 1-9 state a “delegation to any” policy under which any user allowed to execute a task can delegate to any other user. Lines 12-21 state a delegation policy similar to that stated on lines 1-9, but which further requires that a delegatee-user must be a user for whom the delegated task is not prohibited (e.g., a user who is not in an excluded owner list for that task or activity). Lines 23-31 also state a delegation policy similar to that stated on lines 1-9, but which further requires that a delegatee-user must be a user for whom the delegated task is explicitly allowed.

With renewed reference to FIG. 13, security properties 1320 in BPMN2-SEC schema 1300 may be designed to list the security properties that the business process should have and that are accordingly evaluated by the SVaaS process. Security properties 1320 may be created on top of an enumeration of security property templates. This approach may be easily extended to support other property templates that can be recast as a Linear Temporal Logic (LTL) formula, which can provide powerful and expressive logic. Security properties that may be defined and supported by an example, SVaaS may, for example, include:
(1) Data confidentiality—The access to sensitive data should be restricted to certain users.
(2) Separation of duty (SoD)—Separation of duty aims to mitigate the risk of fraud by dividing the responsibility in executing critical parts of business processes.
(3) Separation Binding of Duty: In some cases, it may be necessary for a group of BP activities to be performed by only one user so as to ensure the integrity of the data.
(4) Separation Need-to-know (NtK): Users should access only that sensitive data, which is strictly needed to accomplish their tasks i.e. the tasks should be performed in an objective manner. For a critical task, data can be defined that should not be known by the principal executing the task.

FIG. 14C shows a listing portion 1430 of a BPMN2-SEC schema specification of a BPCP that includes, for example, two security properties on lines 2-6 and lines 7-11, respectively, for travel approval process 1100 of FIG. 11. The first security property (lines 2-6) one captures a SoD between a travel request and a travel approval. The second security property (lines 2-6) models an NtK stating that the manager who will approve the travel budget does not need to know the trip purpose.

With renewed reference to FIG. 13, results element 1330 in BPMN2-SEC schema 1300 may be designed to hold the validation results (e.g., 1331-1333) for the BPM of travel approval process 1100 received from the model checker (e.g., SATMC 1240).

FIG. 14D shows a listing portion 1440 of a BPMN2-SEC schema specification of a BPCP that includes validation results, for example, on lines 1, 5-18, and 19-54. Line 1 may for example, indicate that validation result is conclusive i.e. the model checker was able to determine whether there is an attack or not. This result may usually be the case when the business process does not feature complex loops. Specifically, the model checker may have found as indicated on lines 5-18 that an attack was found on one of the SoD security properties. Lines 19-54 may show the counter-example trace of the attack. The counter-example trace shown in the figure indicates that in the range of business process model possibilities: Karl can claim and execute a Travel Request for himself. Possibly, Karl can be delegated to handle Mickael' managerial activities (delegation of permission) by manager Mickael, for example, when Mickael gets sick suddenly. Karl having all the permissions associated with the manager role may claim and execute the approval of his own travel request in violation of the SoD requirement.

After BPCP 1250 is prepared by SVaaS connector 1220 using, for example, BMPN2 schema 1300, SVaaS connector 1220 may make BPCP 1250 available to SVaaS server 1210 as a BCPC resource for validation testing of the business process (FIG. 15).

As noted earlier, FIG. 15 shows a medium level view of the example architecture of BP compliance validation platform 1200 for providing SVaaS to diverse business process modeler clients, in accordance with the principles of the disclosure herein. As shown in the figure, SVaaS connector 1220 may include a loader component 1221, a persistency 1222, a UI 1223, and a Representational State Transfer (REST) client 1224, all operating under the supervision of a controller 1225. Further, as shown in the figure, SVaaS server 1210 may include a REST API 1211, which is coupled to a request handler 1212, a BPC tracker 1213, a SVaaS portal 1214, a persistency manager 1215, a BPC workers manager 1217 and BPC workers 1218.

In SVaaS connector 1220, persistency 1222 may be used to hold the configuration parameters of SVaaS connector 1220 and the BPCP resource (e.g., BPCP 1250). Persistency 1222 may be further optionally configured to keep a history of all the validations that were carried out by business analysts using the specific SVaaS connector 1220. Loader component 1221 may be configured to collect and load data (e.g., security properties to be validated) from the BPM client (e.g., BPM client 1230) to create the BPCP resource. It may be the case in some instances that not all the data (e.g., the security properties to be validated) necessary for a complete definition of a BPCP resource is available or can be loaded from the BPM client. UI 1223 may provide graphical controls, for example, to collect the missing data. UI 1223 may also provide graphical controls to configure SVaaS connector 1220, to trigger the security validation process overall, and to render the validation results. REST client 1224 may be configured to prepare and send REST requests to REST API 1211 of SVaaS server 1210.

It will be noted that a BPM client may opt for different integration strategies with SVaaS ranging from a heavy level of integration in which SVaaS connector 1220 components (e.g., Loader 1221 and UI 1223) are implemented with high degree of customization for the BPM client, to a light level of integration in which, for example, the rendering of the validation result or even the entire validation activity (including security requirement specification) are outsourced to SVaaS server 1210 hosted in the cloud.

As shown in FIG. 15, SVaaS server 1210 may expose its REST API 1211 to receive REST requests from REST client 1224 of SVaaS connector 1220. The received REST requests (which may include BPCPs) are handled by request handler 1212. The BPCPs (e.g., BPCP 1216) may be REST resources that are stored with their validation status in a persistency layer (e.g., persistency manager 1215). BPC broker 1213 may track and queue all pending BPCPs, which are then individually pulled from the queue by BPC workers 1218 in order to be validated. A BPC worker 1218 may first translate the pulled BPCP into its formal representation in ASLan using translation layer 1218A. The translation of the workflow may, for example, be realized using the security validation approach described with reference to the description of FIGS. 1-10 above.

REST API 1211 through which SVaaS connector 1220 and SVaaS 1210 interact may feature methods for managing BPCPs. The methods may, in particular, relate to creation of BPCPs and reading of the validation results. In order to instantiate a new BPCP, SVaaS connector 1220 may export a set of information from its associated BPM client (e.g., BPM client 1230) to create a BPCP meta-model. To allow the BPM client to export different files in parallel, REST API 1211 may define a multiple-step resource creation. First, a new BPCP resource associated with a requested validation may be created at a specific location on SVaaS server 1210. This validation resource may be unique and may remain accessible at the specific location to the end-user. The only action required of the end-user BPM client to initiate creation of the BPCP resource may be the sending of a POST to SVaaS server URL/validation/. After sending the POST, the BPM client may export the set of information required to feed the newly created BPCP resource. To do so, the client may send PUT requests associated with data on specific nested elements of the validation resource location/BPCP resource.

FIG. 16 shows an example sequence diagram for creating a BPCP or validation resource. In the example sequence diagram shown, “123” is the value returned as the resource location in response to a POST request. The sequence diagram also shows two PUT requests made by the BPM client to upload, for example, the BPMN2 and BPMN2-SEC elements of the BPCP resource.

After the creation of the validation resource location, the BPM client may start the validation process by asking for a validation result (e.g., result element 1330) of the specific BPCP resource with a GET request. The GET request may be treated asynchronously while SVaaS server runs the validation processes. The validation result may be asynchronously returned to the BPM client using, for example, a WebSocket mechanism, a long-polling technique, or a simple polling technique.

FIG. 17 shows an example sequence diagram for returning the validation result to the BPM client using a simple polling technique. As shown in the example sequence diagram, the BPM client may, for example, send polling GET requests (e.g., every 5-10 seconds) till it gets either the validation result or an error message. The BPM client may also receive various response status codes on the status of the validation process in response to the various GET requests during the polling.

Further aspects of the disclosure herein relate to the translation of BPMN2-SEC into ASLan using, for example, translation layer 1218A in BPC worker 1218. A few illustrative examples of the translation of BPMN2-SEC into ASLan are presented below.

BPMN2-SEC (e.g., BPMN2-SEC schema 1300, FIG. 13) includes a policy element (policy element 1310), which includes elements that respectively correspond to RBAC and a delegation policy. RBAC includes the specification of roles, users, permissions. The definition of the roles, users and permissions in ASLan may be realized by defining constants capturing their semantics as follows:
r_manager, r_staff, r_reception to define the roles in lines 3-5 of listing 1410 (FIG. 14A), and
u_mickael to define the user in line 9 of listing 1410.

The specification of positive/negative permissions and of the user assignment in ASLan may be accomplished by defining facts, i.e. atomic propositions. In particular,
permission(execute, approveTravel) may represent the positive permission of lines 15-20 of listing 1410,
prohibition(execute, requestTravel) may represent the negative permission of lines 21-26 of listing 1410, and
ua(u_mickael, r_manager) may state that user u_mickael is assigned the role r_manager (line 12 of listing 1410).

The specification of the assignment of permissions to users and roles may be expressed in ASLan as Horn clauses. Horn clauses offer a declarative way to specify dependencies among facts. The assignment of the permission to execute the task approveTravel to the role r_manager may be defined as follows:

hc permission_assignment_approveTravel :=
pa(r_manager, permission(execute, approveTravel))

Similarly, the assignment of the negative permission to the role receptionist can be defined as follows:

hc permission_assignment_requestTravel :=
pa(r_receptionist, prohibition(execute, requestTravel))

The assignment of the permission to execute a task in BPMN2-SEC implicitly includes the permission to the user to claim the task in order to be able to execute it. However in the formal model such permission assignment may have to be made explicit. This may be done by Horn clauses propagating the execute permissions to claim permissions for the principal, i.e. either users or roles, as follows:

hc claim_propagationuser (U0, HT0) :=
pa(U0, permission (claim, HTO)) :- pa (Ro, permission (Execute, HT0))
hc claim_propagationrole (U0, HT0) :=
pa(U0, permission (claim, HTO)) :- pa (Ro, permission (Execute, HT0))

The authorization of users to claim the execution of a task may be then expressed by the following Horn clauses:

hc claim_task_role (U0, R0,HT0) :=
can_claim (U0, R0, HT0) :- user_to_role (U0,R0), pa (Ro, permission
(claim, HT0)), and
hc claim_task_user (U0, R0,HT0) :=
can_claim (U0, R0, HT0) :- user_to_role (U0,R0), pa (Ro, permission
(claim, HT0))

The first clause in the foregoing recalls the RBAC model and the second expresses a direct assignment of users to tasks. To ensure that users assigned to a role having a prohibition cannot acquire the permission to claim or execute a task via other roles, the prohibition involving roles may be flattened to users by the following Horn clause:

hc prohibition_propagations (U0, R0,HT0, A0) :=
pa (U0, prohibition(A0, HT0) :- user_to_role (U0,R0), pa (Ro,
Prohibition (A0, HT0)).

All of the above defined facts may then be used to define the transitions representing the claim and execution of a task, respectively. The claim of a task can be expressed in ASLan by the following rewrite rule:

step_claim(U0,N0,R0,HT0):=
ready(task(HT0,N0)).
can_claim(U0,R0,HT0).
not(pa(U0,prohibition(claim,HT0)))=>
granted(U0,R0,task(HT0,N0)),

where granted(U0,R0,task(HT0,N0)) expresses the fact that user U0, having the permission to claim task HT0_(can_claim(U0,R0,HT0)) and not being prohibited from doing so, claimed the execution of the instance N0_of task HT0_and is then in charge of performing it. Then, the execution of human tasks by an authorized user may be expressed by the following rewrite rule

step_human_task_execution(U0,S1,S0,N0,R0,HT0):=
granted(U0,R0,task(HT0,N0)). task_to_data(HT0,S0,S1)=>
executed(U0,task(HT0,N0)). aknows(U0,S0). aknows(U0,S1).
done(task(HT0,N0)). task_to_data(HT0,S0, S1),

which states that the instance N0 of human task HT0 is executed by a user U0, i.e. executed(U0, task(HT0, N0)), if U0 obtained the right to execute task HT0 acting in role R0, i.e. granted(U0, R0, task(HT0, N0)). It will be noticed that as a result user U0 accessed, and thus knows, the sets of input and output data of the task, i.e. aknows(U0, S0), aknows(U0, S1).

As noted earlier policy element 1310 of BPMN2-SEC 1300 includes a delegation policy element 1312, which also allows implicit or explicit definitions of delegation.to define delegation. Lines 12-21 of a listing 1420 (FIG. 14B) show an example of an implicit delegation provided for a BPM client by which users can delegate a claimed task to a delegatee provided that the delegatee is not prohibited the execution. This delegation policy may, for example, be expressed in ASLan as follows:

```
hc_implicit_delegation_of_execution_(HT0,U0,U1) :=
can_delegate_execution(U0,U1,HT0) :-pa(U0,permission(execute,HT0))
  hc_implicit_delegation_of_execution_0(HT0,U0,U1,R0):=
  can_delegate_execution(U0,U1,HT0) :-
  user_to_role(U0,R0),pa(R0,permission(execute,HT0)).
  step_step_delegation_of_execution(U0,R1,N0,R0,HT0,U1) :=
  user_to_role(U1,R1).
  granted(U0,R0,task(HT0,N0)).
  can_delegate_execution(U0,U1,HT0).
  not(pa(U1,prohibition(execute,HT0)))&
  not(equal(U0,_U1))=>
  granted(U1,R1,task(HT0,N0
  user_to_role(U1,R1)
```

Properties element 1320 of BPMN2-SEC schema 1300 may allow definition of security desiderata that are not mandatory or enforced for a business process. However, business process modelers may still need to prove that the business process achieves them. Such security desiderata can be expressed in ASLan as attack states representing the situation in which the properties are violated. As an example, the separation of duty (SoD) in lines 2-6 of listing 1430 (FIG. 14C) can be expressed by an attack state as follows:

| | |
|---|---|
| attack_state | sod_1(U,N0,N1):= |
| | executed(U,task(requestTravel,N0)). |
| | executed(U, task(approveTravel,N1)), |

where a user U executed both tasks.

Similarly, the property in lines 7-11 of listing 1430 (FIG. 14C) can be expressed by an attack state

```
attack_state needtoknow1(U,N0,Set):=_{—}
      executed(U, task(approveTravel,N0)).
      aknows(U, Set)
      contains(Set, mc_pair(travelData,reason)),
```

where a user U executes the task approveTravel while knowing the reason field of the travelData object.

After translating BPCP, translation layer 1218A in SVaaS 1210 may feed the ASLan representation to an instance of SATMC 1240 for model checking via model checker manager 1218B. It may be expected that the SATMC model checking processes may be computationally intensive and time consuming. Accordingly, for performance, one SATMC process may be run at a time on one virtual machine with 100% CPU and a reasonable RAM allocation. BPC workers manager 1217 may, on-the-fly, start a new BPC worker thread and a corresponding external virtual machine with a new SATMC instance for a next validation request as soon as certain customer-dependent workload criteria are met. As soon as the model checker (SATMC) finishes its validation analysis, BPC worker 1218 may translate the validation result or outcome into a proper XML format so that it can be filled into result element 1330 of the BPCP resource. Once the validation result is filled it may be ready to be consulted.

SVaaS portal 1214 in SVaaS server 1210 may provide a single web-based entry-point for the end-users to monitor the status of all their BPCP resources. SVaaS portal 1214 may also be configured to make a suitable security validation environment available for those BPM clients that may want to opt for a light integration with SVaaS.

FIG. 18 is a flowchart illustrating an example computer-implemented method 1800 for providing Security Validation as a Service (SVaaS) remotely to one or more business process modeler (BPM) clients, in accordance with the principles of the disclosure herein.

Method 1800, which is implemented by executing instructions stored on a computer readable storage medium, includes receiving on a server (e.g., hosted on a cloud-based platform), from a remote BPM client, a request for validation of a business process model and related information for a business process compliance problem (BPCP) including the business process work flow and security-related aspects of the business process (1810), sending the BPCP from the server to a model checker for validation (1820), receiving, at the server, validation results from the model checker (1830), and making the validation results available to the remote business process modeler client (1840).

Further, method 1800 may also include creating a unique BPCP resource object associated with the request for validation at a specific location on server, wherein the unique BPCP resource object has a schema that includes at least a security policy element, a security property element and a result element (1850) and placing the validation results received at the server in a BPCP resource object wherefrom the validation results are accessible to the remote BPM client (1860). The BPCP may be in Business Process Modeling Notation (BPMN) language. Method 1800 may include translating BPCP from BPMN language to a meta-language used by the model checker and conversely translating the validation results received from the model checker from the meta-language to BPMN language (1870).

Method 1800 may include enhancing the remote BPM client with a connector module that is configured to collect information on the business process compliance problem and to communicate such information to the server (1870). Method 1800 may also include providing a single web-based entry-point on the server for the end-users to monitor their BPCP resources on the server (1880).

A computer program product is tangibly embodied on a computer-readable storage medium and includes instructions that, when executed, enhance a business process modeler (BPM) client with a connector module. The connector module may be configured to send, to a remote server, a request for validation of a business process model and related information for a business process compliance problem (BPCP) including the business process work flow and security-related aspects of the business process. The connector module may be further configured to receive, from the remote server, validation results for the business process compliance problem.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

What is claimed is:

1. A server configured to remotely provide Security Validation as a Service (SVaaS) to one or more business process modeler (BPM) clients, the server including instructions recorded on a computer-readable medium and executable by at least one processor, the server comprising:
an application programming interface (API) configured to receive, from a remote BPM client, a request for validation of a business process model and related information for a business process compliance problem (BPCP) including the business process work flow and security-related aspects of the business process; and
a model checking manager configured to send the BPCP to a model checker for validation and to receive validation results therefrom.

2. The server of claim 1, wherein the API is configured to receive or create a unique BPCP resource object associated with the request for validation at a specific location.

3. The server of claim 2, wherein the unique BPCP resource object has a schema that includes at least a security policy element, a security property element and a result element.

4. The server of claim 2, wherein the API is configured to accept PUT requests from the remote BPM client to place information for the business process compliance problem in the unique BPCP resource object associated with the request for validation at the specific location.

5. The server of claim 1 further configured to place the validation results in a BPCP resource object wherefrom the validation results are accessible by the remote BPM client.

6. The server of claim 1, further comprising a portal configured to provide a single web-based entry-point for the end-users to monitor their BPCP resources on the server.

7. The server of claim 1, wherein the remote BPM client is enhanced with a connector module that is configured to collect information on the business process compliance problem and to communicate such information to the API on the server.

8. The server of claim 1, wherein the BPCP is in Business Process Modeling Notation (BPMN) language, and wherein the server further comprises a translation layer configured to translate the BPCP from BPMN language to a meta-language used by the model checker and to conversely translate the validation results received from the model checker from the meta-language to BPMN language.

9. The server of claim 5, wherein the meta-language is AVANTSSAR Specification Language (ASLan) that allows the execution of the tasks in the business process by the model checker.

10. The server of claim 1, wherein the model checker processes for validation of the business process model are run on one virtual machine, and wherein a workers manager module in the server is configured start a new worker thread and a corresponding external virtual machine with a new model checker instance for a next request for validation received by the server as soon as workload criteria are met.

11. A computer-implemented method for providing Security Validation as a Service (SVaaS) remotely to one or more business process modeler (BPM) clients, the method implemented by executing instructions stored on a computer readable storage medium, the method comprising:
receiving on a server, from a remote BPM client, a request for validation of a business process model and related information for a business process compliance problem (BPCP) including the business process work flow and security-related aspects of the business process;
sending the BPCP from the server to a model checker for validation; and
receiving, at the server, validation results from the model checker.

12. The method of claim 11, further comprising enhancing the remote BPM client with a connector module that is configured to collect information on the business process compliance problem and to communicate such information to the server.

13. The method of claim 11, further comprising creating a unique BPCP resource object associated with the request for validation at a specific location on server, wherein the unique BPCP resource object has a schema that includes at least a security policy element, a security property element and a result element.

14. The method of claim 11, further comprising placing the validation results received at the server in a BPCP resource object wherefrom the validation results are accessible to the remote BPM client.

15. The method of claim 11, further comprising providing a single web-based entry-point on the server for the end-users to monitor their BPCP resources on the server.

16. The method of claim 11, wherein the BPCP is in Business Process Modeling Notation (BPMN) language, and wherein the method further comprises:
translating BPCP from BPMN language to a meta-language used by the model checker; and
translating the validation results received from the model checker from the meta-language to BPMN language.

17. A computer program product, the computer program product being tangibly embodied on a computer-readable storage medium and comprising instructions that, when executed, enhance a business process modeler (BPM) client with a connector module that is configured to:
send, to a remote server, a request for validation of a business process model and related information for a business process compliance problem (BPCP) including the business process work flow and security-related aspects of the business process; and
receive, from the remote server, validation results for the business process compliance problem.

18. The computer program product of claim 17, wherein the connector module includes a loader module configured to collect information on the business process compliance problem from the BPM client.

19. The computer program product of claim 17, wherein the connector module includes user interface configured to provide one or more graphical controls configured to collect data on the business process compliance problem not available from the BPM client, configure connector, trigger the validation of the business process model, and to render the validation results.

20. The computer program product of claim 17, wherein the connector module includes a persistency element configured to hold a BPCP resource object which has a schema that includes at least a security policy element, a security property element and a validation result element.
